(19) United States
(12) Patent Application Publication
(10) Pub. No.: US 2007/0040794 A1
(43) Pub. Date: Feb. 22, 2007

(54) Liquid crystal display device repair system and method thereof

(75) Inventors: Yun Hee Kwak, Seoul (KR); Jeong Il Kim, Incheon (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/506,733

(22) Filed: Aug. 17, 2006

(30) Foreign Application Priority Data
Aug. 17, 2005 (KR) 2005-75025

(51) Int. Cl. G09G 3/36

(52) U.S. Cl. 345/100

(57) ABSTRACT

Disclosed are a liquid crystal display (LCD) device which can minimize power consumption and detect whether a repairing process is successful or not during a testing process, and testing and repairing methods thereof. The LCD device includes gate lines formed on a substrate, data lines formed on the substrate by crossing the gate lines, first and second repair lines for repairing at least one signal line of the data lines and gate lines, amplifiers for amplifying a driving signal supplied to the first repair line and supplying the amplified driving signal to the second repair line, and a first passing line to which input terminals of the amplifiers are commonly connected.

### REFERENCE TO RELATED APPLICATION

This application claims priority by virtue of Korean Patent Application No. 2005-75025 filed Aug. 17, 2005.

### FIELD OF THE INVENTION

The present invention relates to a liquid crystal display (LCD) device and, more particularly, to a low power consumption LCD device that can repair a defect and then determine whether a repair is successful.

### DESCRIPTION OF THE RELATED ART

An LCD display includes a matrix of signal lines such as gate lines and data lines and liquid crystal cells that display images by using an electric field to control the liquid crystal's light transmittance. The driving circuit for supplying the electric field includes a plurality of integrated circuits (ICs) for driving the gate lines and a data lines. The ICs, packaged on tape carrier packages (TCPs) may be connected to the LCD panel by a tape automated bonding (TAB) method or packaged on the LCD panel by a chip-on-glass (COG) method. In the connection process sometimes open-circuit defects occur in the signal lines, data lines or gate lines which decrease the yield of acceptable devices.

In order to detect and repair such open circuits, a signal line and a repair line are shorted and an operational amplifier installed on the printed circuit board supplies a pixel voltage signal to repair the line. In this case, since the operational amplifier always consumes power irrespective of whether the shorted signal line has been repaired or not, there is inefficient power consumption.

### SUMMARY OF THE INVENTION

In accordance with an aspect of the present invention an LCD device is provided that can detect whether a repair process is successful or not during a testing process. In accordance with an aspect of the present invention, if a signal line is opened, amplifiers of the first and last integrated circuits are enabled, and amplifiers of the other integrated circuits are disabled. Further, if a signal line is opened, a common line connected between a power voltage terminal and a repair amplification terminal of each of the amplifiers is connected to enable the amplifiers. The LCD device further includes a second passing line connected between output terminals of the first and last driving integrated circuits and the second repair line.

### BRIEF DESCRIPTION OF THE DRAWING

The above and other objects, features and advantages of the present invention will become more apparent from the following detailed description when taken in conjunction with the accompanying drawing in which:

FIG. 1 is a diagram illustrating an LCD device according to a first embodiment of the present invention;

FIG. 2 is a diagram illustrating an operational amplifier included in a data driver IC shown in FIG. 1;

FIG. 3 is a diagram for describing a repair process of the LCD device according to the first embodiment of the present invention;

FIG. 4 is a diagram illustrating an LCD device according to a second embodiment of the present invention;

FIG. 5 is a plane view illustrating a plurality of pads formed on a thin film transistor substrate shown in FIG. 4;

FIG. 6 is a diagram for describing a repair process of the LCD device according to the second embodiment of the present invention;

FIG. 7 is a diagram illustrating an LCD device according to a third embodiment of the present invention; and

FIG. 8 is a diagram for describing a repair process of the LCD device according to the third embodiment of the present invention.

### DETAILED DESCRIPTION OF THE PREFERRED EMBODIMENT

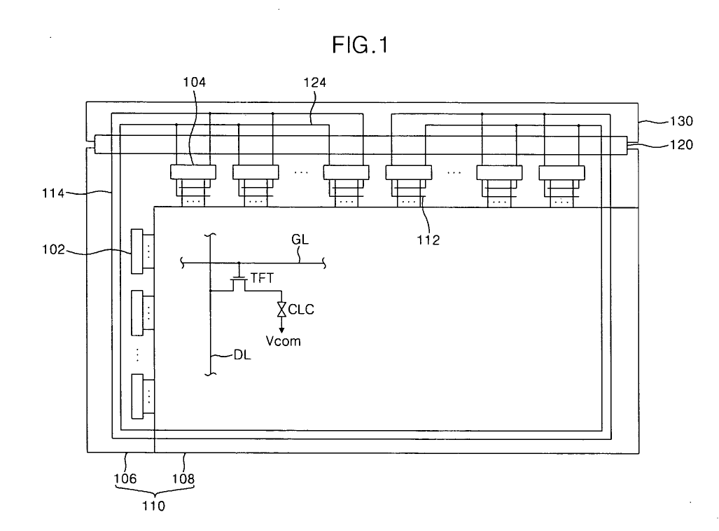

Referring to FIG. 1, the LCD device includes an LCD panel 110, data driver ICs 104 for driving data lines DL of the LCD panel 110, and gate driver ICs 102 for driving gate lines GL of the LCD panel 110. The gate driver ICs 102 sequentially supply scan pulses to the gate lines GL in response to a gate control signal received from a timing controller (not shown) to drive the thin film transistors TFT. The data driver ICs 104 convert digital video data into an analog gamma voltage corresponding to a gray level.

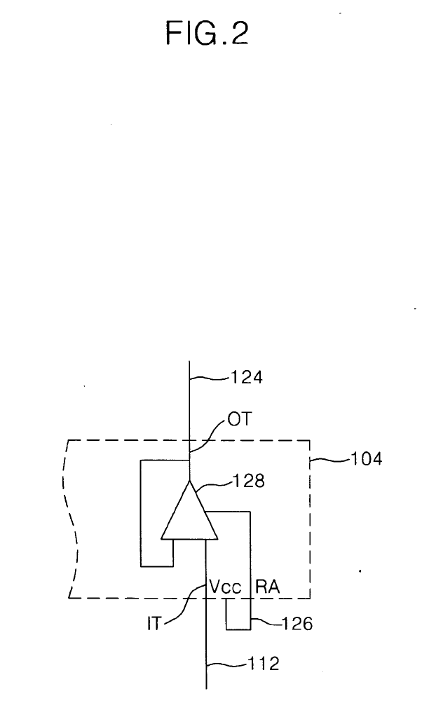

Each data driver IC 104 includes two operational amplifiers such as amplifier 128 shown in FIG. 2. Each operational amplifier 128 includes an input terminal IT connected to a first repair line 112, an output terminal OT for connection to a passing line 124 formed on FPC 120 and PC 130, and a power voltage terminal Vcc. A repair amplification terminal RA is normally connected to terminal VCC through U-shaped common line 126.

When the power voltage terminal Vcc and repair amplification terminal RA are commonly connected by the U-shaped common line 126, even if a pixel voltage signal is supplied to the input terminal IT, the operational amplifier 128 is in a disabled state. On the other hand, when the common line 126 is opened by a laser cutting process, if the pixel voltage signal is supplied to the input terminal IT, the operational amplifier 128 becomes an enabled state which generates a repair pixel voltage signal by amplifying the pixel voltage signal.

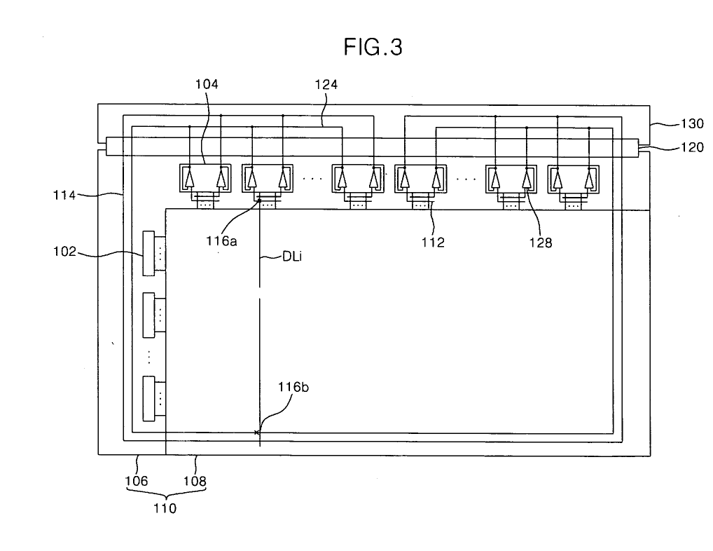

The repair pixel voltage signal is supplied to the passing line 124 through the output terminal OT of the operational amplifier 128. Such an operational amplifier 128 prevents a delay of the repair pixel voltage signal caused by a second repair line 114 which is formed to detour a display region. As shown in FIG. 3, the output terminals OT of the operational amplifiers 128 are commonly connected to the passing lines 124 formed on thin film transistor substrate 106, a flexible printed circuit board (FPC) 120 and a printed circuit board 130 so as to be connected to the second repair lines.

An LCD panel 110 includes the thin film transistor substrate 106 and a color filter substrate 108 which face each other, and a liquid crystal injected between the two substrates 106 and 108. The color filter (upper) substrate 108 includes color filters for separating the color filters from one another and reflecting external light, a common electrode for supplying a reference voltage Vcom to liquid crystal cells CLC, and an alignment film. The thin film transistor substrate 106 includes gate lines GL, data lines DL, thin film transistors TFT switching elements at intersections of the gate lines GL and data lines DL, pixel electrodes connected to the thin film transistors TFT.

The thin film transistor substrate 106 includes first and second repair lines 112 and 114 for repairing opened data lines. The first repair lines 112 are selectively connected to the input terminals IT of the operational amplifiers 128 included in each data driver IC 104. During a repair process, the first repair lines 112 are connected to one part of an opened data line. The second repair lines 114 are connected to the passing lines 124 and formed to detour the display region. During a repair process, the second repair lines 114 are connected to the other part of the opened data line.

The repair process of the LCD device will now be described with reference to FIG. 3. As shown, if an open occurs at an i-th (where i is a natural number) data line DLi, the laser repair process will short the i-th data line DLi to the adjacent first repair line 112 at intersection 116a. Further, the laser repair process will short the i-th data line DLi and the adjacent second repair line 114 at intersection 116b. Thereafter, the power voltage terminal Vcc and the repair amplification terminal RA of the operational amplifier 128 of the data driver IC 104 connected to the i-th data line DLi are opened by a laser cutting process. This allows the pixel voltage signal on the i-th data line DLi to be supplied to the input terminal IT of the operational amplifier 128 through the first repair line 112. Then the operational amplifier 128 generates a repair pixel voltage signal by amplifying the pixel voltage signal. The repair pixel voltage signal is supplied to the i-th data line DLi through the passing line 124 and the second repair line 114. Thus the LCD device according to the first embodiment of the present invention repairs opened data lines DLi by using the operational amplifiers 128 of which output terminals are commonly connected to the passing lines 124 and using the first and second repair lines 112 and 114. Hence, the LCD device can selectively enable the operational amplifiers corresponding to the opened data lines, thereby reducing power consumption.

On the other hand, the LCD device according to the first embodiment of the present invention necessarily demands the laser cutting process for enabling the operational amplifier 128 corresponding to the opened data line. However, since the opened data line DLi is not fixed, the operational amplifier 128 necessitating the laser cutting process is not fixed either. In this case, there is strong probability that another operational amplifier other than the corresponding operational amplifier is subject to the laser cutting process by mistake.

Moreover, the test process performed before the data driver IC and FPC are packaged cannot determine whether the repair process is successful or not. In other words, despite the fact that the operational amplifier 128 corresponding to the opened data line DLi should be selectively enabled, the LCD device according to the first embodiment of the present invention can not selectively enable the operational amplifier 128 packaged in a test unit. Furthermore, if all the operational amplifiers 128 packaged in the test unit operate, a determination cannot be made of whether a signal supplied to the second repair line 114 is a pixel voltage signal or a noise signal. This is because the output terminals of the operational amplifiers 128 are commonly connected to the passing line 124 and thus a repair pixel voltage signal amplified by the operational amplifier corresponding to the opened data line or a noise signal generated from the operational amplifier corresponding to a non-opened data line may be supplied to the second repair line 114.

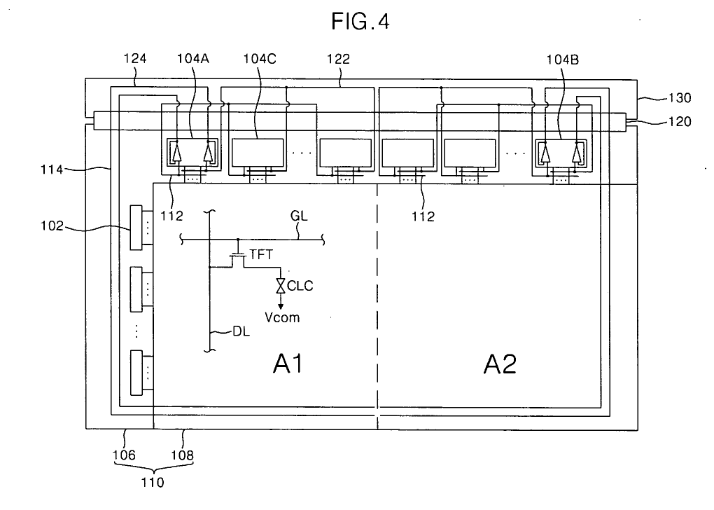

FIG. 4 illustrates an LCD device according to a second embodiment of the present invention. The LCD device of FIG. 4 includes the same elements as the LCD device of FIG. 1 except that input terminals of operational amplifiers 128 are commonly connected to the first passing line 122 formed on the FPC 120 and the PC 130. Therefore, a detailed description of the same elements will be omitted. The operational amplifier 128 prevents a delay of a repair pixel voltage signal caused by the second repair line 114 formed to detour the display region. For this, the operational amplifier 128 includes the input terminal IT connected to the first passing line 122 through the first repair line 112, the output terminal OT connected to the second repair line 114 through a second passing line 124, and the power voltage terminal Vcc and repair amplification terminal RA which are commonly connected to the common line 126 formed in a ‘U’ shape on the lower substrate.

When the power voltage terminal Vcc and repair amplification terminal RA are commonly connected to the common line 126, even if a pixel voltage signal is supplied to the input terminal IT of the operational amplifier 128, the operational amplifier 128 remains in a disabled state. On the other hand, when the common line 126 is opened by a laser cutting process, if the pixel voltage signal is supplied to the input terminal IT of the operational amplifier 128, the operational amplifier 128 will be enabled and can amplify the pixel voltage signal. If an opened data line is detected, the first data driver IC 104A and the last data driver IC 104B are enabled (by opening their corresponding common line 126. The other data driver ICs 104C remain disabled.

The repair pixel voltage signal amplified through the operational amplifiers 128 included in the first and last data driver ICs 104A and 104B is supplied to the opened data line through the output terminals OT of the operational amplifiers 128, the second passing line 124 and the second repair line 114. The input terminals of the operational amplifiers 128 included in the respective data driver ICs 104 are commonly connected to the first passing line 122 through the first repair line 112.

The second passing line 124 is connected between each of the output terminals of the operational amplifiers 128 included in the first and last data driver ICs 104A and 104B and the second repair line 114.

The first and second passing lines 122 and 124 are formed on the FPC 120 and the printed circuit board 130. The thin film substrate 106 of the LCD panel 110 includes the first and second repair lines 112 and 114 for repairing opened data lines.

The first repair lines 112 are selectively connected to the input terminals IT of the operational amplifiers 128 included in the respective data driver ICs 104 and cross the data lines DL. The first repair lines 112 corresponding to the respective data driver ICs 104 are commonly connected to the first passing line 122 formed on the printed circuit board 130 and the FPC 120. If the data line is opened, the first repair line 112 is connected to the upper part of the opened data line by a laser repair process.

The second repair lines 114 are connected to the second passing lines 124 formed on the printed circuit board and the FPC 120 and formed to detour the display region. Especially, the second repair lines 114 connected through the second passing lines 124 to the output terminals of the first data driver IC 104A are formed to detour one side A1 of the display region. The second repair lines 114 connected through the second passing lines 124 to the output terminals of the last data driver IC 104B is formed to detour the other side A2 of the display region. If the data line is opened, the second repair line 114 is connected to the lower part of the opened data line by the laser repair process.

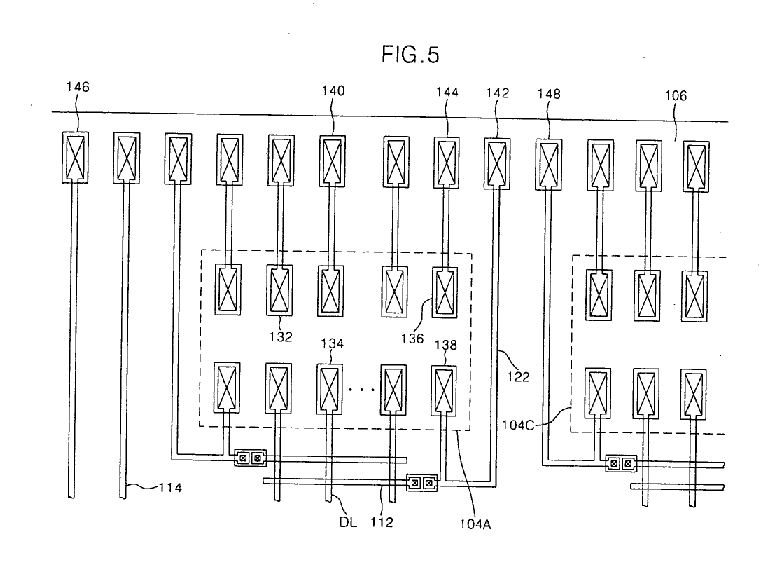

The thin film transistor substrate 106 of the LCD panel 110 according to the second embodiment of the present invention further includes, as shown in FIG. 5, an FPC pad 140 connected to the FPC 120, a passing input pad 148, a passing output pad 142, a second repair pad 146, an FPC repair pad 144, an IC input pad 132 and a first repair input pad 138 connected to the input terminal of the data driver IC 104, and an IC output pad 134 and a first repair output pad 136 connected to the output terminal of the data driver IC.

The FPC pad 140 connected to the FPC 120 supplies the IC input pad 132 with a data control signal and pixel data generated from the timing controller packaged on the printed circuit board 130 and a driving voltage generated from a power supply.

The passing input pad 148 is connected through the first repair line 112 and the first passing line 122 to the input terminals IT of the operational amplifiers 128 included in the data driver ICs 104C except the first and last data driver ICs 104A and 104B. A pixel voltage signal received from the first repair lines 112 corresponding to the data driver ICs 104C except the first and last data driver ICs 104A and 104B is supplied to the passing input pad 148.

The passing output pad 142 is connected to the input terminals IT of the operational amplifiers 128 included in the first and last data driver ICs 104A and 104B through the first repair line 112 and the first passing line 122. The passing output pad 142 supplies a pixel voltage signal received from the passing input pad 148 to the input terminals of the operational amplifiers 128 included in the first and last data driver ICs 104A and 104B.

The FPC repair pad 144 is extended from the first repair output pad 136 connected to the output terminals OT of the operational amplifiers 128 included in the first and last data driver ICs 104A and 104B. The FPC repair pad 144 supplies a repair pixel voltage signal generated from the operational amplifiers 128 included in the first and last data driver ICs 104A and 104B to the second passing line 124 formed on the FPC 120. The second repair pad 146 is extended from the second repair line 114. The second repair pad 146 is connected to the second passing line 124 formed on the FPC 120 and supplies a repair pixel voltage signal generated from the operational amplifiers 128 included in the first and last data driver ICs 104A and 104B to the second repair line 124.

The IC input pad 132 supplies pixel data, a control signal and a power signal generated from the timing controller and power supply packaged on the printed circuit board 130 to the data driver ICs 104 through the FPC output pad 140.

The first repair input pad 138 supplies a pixel voltage signal received from the first repair line 112 to the input terminal IT of the operational amplifier 128 included in the first or last data driver IC 104A or 104B. In this case, the first repair line 112 is shorted by a laser repair process together with the data line DL corresponding to the first or last data driver IC 104A or 104B. The IC output pad 134 is extended from the data line DL and supplies a pixel voltage signal generated from the data driver IC 104 to the data line DL.

The first repair output pad 136 supplies a repair pixel voltage signal amplified by the operational amplifier 128 included in the first or last data driver IC 104A or 104B to the FPC repair pad 144.

In the LCD device according to the second embodiment of the present invention, a determination is made of whether the LCD panel has a defect by supplying a test signal to the data line before the driver IC is packaged on the substrate and the FPC is attached to the LCD panel. A description will be made of a test process of the above-mentioned LCD device with reference to FIGS. 4 and 5.

For the test process, a test signal is supplied to the data lines DL, and a test unit is provided in which a plurality of amplifiers for amplifying a pixel voltage signal is installed. The amplifiers are installed by the unit of data driver ICs to be connected to the data lines. Among the plurality of amplifiers installed in the test unit, amplifiers connected to data lines corresponding to the first and last data driver ICs become an enabled state, and the other amplifiers connected to data lines corresponding to the other data driver ICs become a disabled state.

By using this test unit, the LCD device is driven. While the LCD device is driven, a determination is made of whether a repair pixel voltage signal amplified by the operational amplifier is supplied to a opened data line through the second repair line 114. If the repair pixel voltage signal is supplied to the opened data line, it is concluded that the LCD panel has good quality because the repair process of the opened data line is judged to successful.

At least one of the data driver IC and the gate driver IC is packaged on the LCD device which has obtained good quality, as illustrated in FIG. 4. Moreover, an FPC for supplying a driving signal to the packaged driver IC is attached to the LCD device.

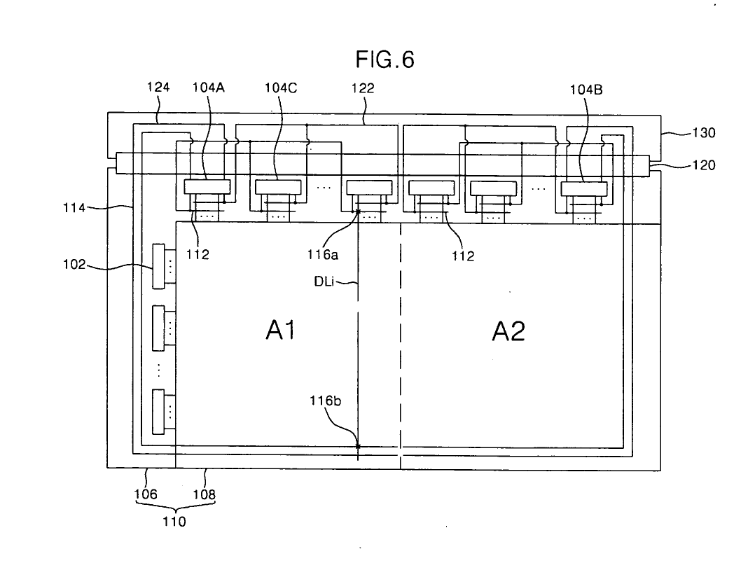

A repair process of such an LCD device will now be described with reference to FIG. 6. As shown, if an open occurs at an i-th (where i is a natural number) data line DLi connected to the third data driver IC 104C, an intersection 116a of the i-th data line DLi and the adjacent first repair line 112 is shorted by a laser repair process. Further, an intersection 116b of the i-th data line DLi and the second repair line 114 is shorted by the laser repair process. Thereafter, the power voltage terminal Vcc and the repair amplification terminal RA of the operational amplifier 128 included in the first data driver IC 104A are opened. In this case, a pixel voltage signal is supplied to the input terminal IT of the operational amplifier 128 included in the first data driver IC 104A through the i-th data line DLi, the first repair line 112 connected to the i-th data line DLi, the first passing line 122, and the first repair line 112 corresponding to the first data driver IC 104A. Then the operational amplifier 128 included in the first data driver IC 104A generates a repair pixel voltage signal by amplifying the pixel voltage signal. The repair pixel voltage signal is supplied to the i-th data line DLi through the output terminal of the operational amplifier 128, the second passing line 124 and the second repair line 114.

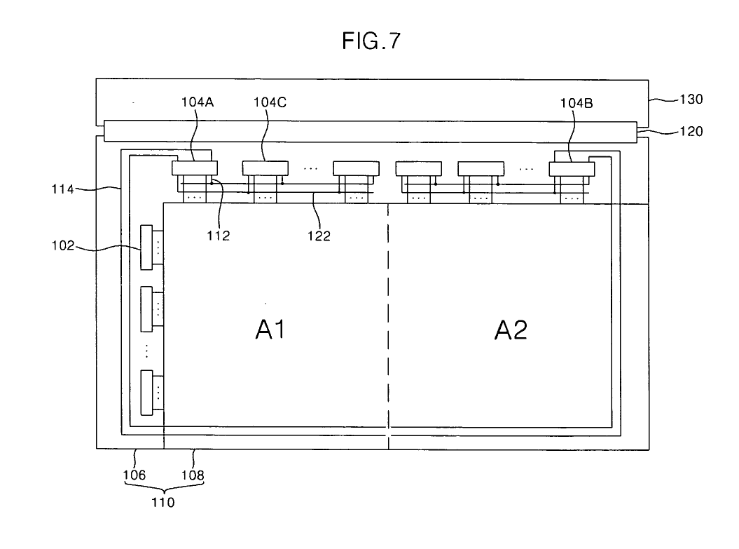

FIG. 7 illustrates an LCD device according to a third embodiment of the present invention. The LCD device of FIG. 7 includes the same elements as that of FIG. 4 except that the passing line is formed on the thin film transistor substrate 106. Therefore, a detailed description of the same elements will not be given. The operational amplifiers 128 included in the data driver ICs 104 maintain a disabled state if no opened data line is detected. However, if an opened data line is detected, the operational amplifiers included in the first and last data driver ICs 104A and 104B become an enabled state, and the operational amplifiers included in the other data driver ICs 104C except the first and last data driver ICs 104A and 104B maintain a disabled state.

Input terminals of the operational amplifiers included in the respective data driver ICs 104 are commonly connected to the passing lines 122 through the first repair line 112. Since the passing lines 122 are formed on the thin film transistor substrate 106, their length becomes shorter than the passing lines 122 shown in FIG. 4. Accordingly, a delay of a pixel voltage signal supplied to the input terminals of the operational amplifiers 128 included in the first and last data driver ICs 104A and 104B, caused by a line resistance of the passing line 122 can be prevented.

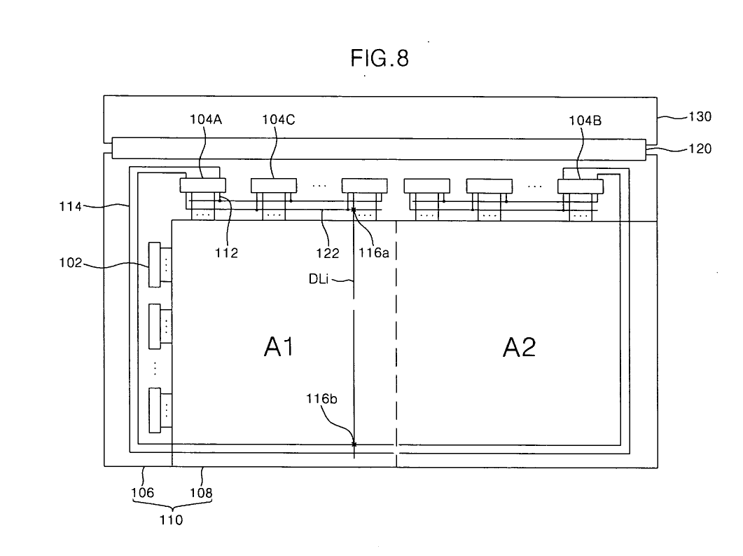

A repair process of such an LCD device will now be described with reference to FIG. 8. As shown, if an open occurs at an i-th (where i is a natural number) data line DLi connected to the third data driver IC 104C, an intersection 116a of the i-th data line DLi and the adjacent first repair line 112 is shorted by a laser repair process. Further, an intersection 116b of the i-th data line DLi and the adjacent second repair line 114 is shorted by the laser repair process. Thereafter, the power voltage terminal Vcc and the repair amplification terminal RA of the operational amplifier 128 included in the first data driver IC 104A are opened. In this case, a pixel voltage signal is supplied to the input terminal IT of the operational amplifier 128 included in the first data drive IC 104A through the i-th data line DLi, the first repair line 112 connected to the i-th data line DLi, the passing line 122, and the first repair line 112 corresponding to the first data driver IC 104A. Then the operational amplifier 128 included in the first data driver IC 104A generates a repair pixel voltage signal by amplifying the pixel voltage signal. The repair pixel voltage signal is supplied to the i-th data line DLi through the output terminal OT of the operational amplifier 128 and the second repair line 114.

On the other hand, it is possible that in the LCD devices of FIGS. 4 and 7 only the first and last data driver ICs 104A and 104B include the operational amplifiers 128, and the other data driver ICs 104C do not include the operational amplifiers 128.

Although the present invention has described the case that the data line is opened, it is also applicable to the case that the gate line is opened. That is, the gate driver IC may include operational amplifiers of which input terminals are commonly connected to each other, and only the first and last gate driver ICs may be selectively enabled when the gate line is opened. As described above, the LCD device according to the present invention includes the operational amplifiers which are included in the driver ICs and of which input terminals are commonly connected to the passing line. Among these operational amplifiers, the operational amplifiers included in the first and last driver ICs become an enabled state during a repair process. Then since the first and last driver ICs selectively become the enabled state during the repair process, power consumption can be minimized. Furthermore, since the LCD device according to the present invention fixedly enables operational amplifiers corresponding to the first and last driver ICs installed in the test unit by a laser cutting process, a worker's mistake can be minimized. Hence, the LCD device can detect whether the repair process is successful or not during a test process and thus yield is improved.

While the invention has been shown and described with reference to a certain preferred embodiment thereof, it will be understood by those skilled in the art that various changes in form and details may be made therein without departing from the spirit and scope of the invention.

What is claimed is:

1. A liquid crystal display device, comprising:
a substrate having signal lines gate lines and data lines;
first and second repair lines for repairing at least one signal line of the data lines and gate lines;
amplifiers for amplifying a driving signal supplied to the first repair line and supplying the amplified driving signal to the second repair line; and
a first passing line to which input terminals of the amplifiers are commonly connected.

2. The liquid crystal display device according to claim 1, further comprising integrated circuits which include the amplifiers and drive at least one signal line of the data lines and gate lines.

3. The liquid crystal display device according to claim 2, wherein if the signal line is opened, amplifiers of the first and last integrated circuits are enabled, and amplifiers of the other integrated circuits are disabled.

4. The liquid crystal display device according to claim 3, further comprising a common line connected between a power voltage terminal and a repair amplification terminal of each of the amplifiers, wherein if the signal line is opened, the common line is shorted to enable the amplifiers.

5. The liquid crystal display device according to claim 1, wherein the first passing line is formed on the substrate.

6. The liquid crystal display device according to claim 3, further comprising a second passing line connected between output terminals of the first and last driving integrated circuits and the second repair line.

7. The liquid crystal display device according to claim 6, wherein at least one of the first and second passing lines is formed on the substrate, a flexible printed circuit board attached to the substrate, and a printed circuit board connected to the flexible printed circuit board.

8. The liquid crystal display device according to claim 6, wherein the second repair line is formed to detour a display region on the substrate.

9. The liquid crystal display device according to claim 1, wherein the signal line is the data line.

10. A method of repairing a liquid crystal display device including a matrix of gate lines and data lines formed on a substrate and first and second repair lines for repairing at least one signal line of the gate lines and data lines, integrated circuits connected to the signal line, amplifiers for amplifying a driving signal supplied to the first repair line and supplying the amplified driving signal to the second repair line, and a passing line to which input terminals of the amplifiers are commonly connected, comprising the steps of:
detecting whether the signal line is opened or not;
shorting the opened signal line from the first and second repair lines;
selectively enabling amplifiers corresponding to the first and last integrated circuits; and
amplifying a driving signal supplied to the enabled amplifiers through the first repair line and the passing line and supplying the amplified driving signal to the second repair line.

11. The method according to claim 10, wherein the second repair line is formed so as to detour a display region on the substrate.

12. The method according to claim 10, wherein the step of selectively enabling amplifiers includes opening a common line between a power voltage terminal and a repair amplification terminal of each of the amplifiers corresponding to the first and last integrated circuits by a cutting process.

13. The method according to claim 10, wherein the signal line is the data line.

14. A method of testing a liquid crystal display device, comprising the steps of:
providing a liquid crystal display device including gate lines formed on a substrate, data lines formed on the substrate and first and second repair lines for repairing at least one signal line of the gate lines and data lines;
providing a test unit in which a plurality of amplifiers for amplifying a driving signal supplied to the first repair line and supplying the amplified driving signal to the second repair line is included, input terminals of the amplifiers being commonly connected to each other; and
testing the liquid crystal display device by using the testing unit.

15. The method according to claim 14, wherein the step of providing the liquid crystal display device includes providing the liquid crystal display device including the second repair line formed to detour a display region on the substrate.

16. The method according to claim 14, wherein the step of providing a test unit includes providing the test unit in which the amplifiers are by the unit of integrated circuits to be connected to the signal line.

17. The method according to claim 17, wherein the step of providing a test unit includes providing the test unit in which amplifiers corresponding to the first and last integrated circuits are enabled and the other amplifiers are disabled.
